(19) United States
(12) Patent Application Publication
(10) Pub. No.: US 2024/0046343 A1
(43) Pub. Date: Feb. 8, 2024

(54) METHOD, APPARATUS AND SYSTEM FOR AUCTION OF ASSETS

(71) Applicant: BGC PARTNERS, L.P., New York, NY (US)

(72) Inventors: Rajat Mehta, New York, NY (US); Bijoy Paul, New York, NY (US)

(21) Appl. No.: 17/817,111

(22) Filed: Aug. 3, 2022

(51) Int. Cl. G06Q 30/08

(52) U.S. Cl. CPC G06Q 30/08

(57) ABSTRACT

Method, apparatus and system may control determining possible order matches of orders for an auction of an asset at a top of an order book by price, size and a pro rata matching process prior to a time that the auction commence, and atomic matching the possible order matches at the time that the auction commences.

### TECHNICAL FIELD

The present disclosure generally relates to trading of assets electronically in an auction and, in particular, prior to a time that an auction of assets commences, determining possible order matches of orders at a top of an order book, by price and size and pro rata matching, and atomic matching the order matches at the time that the auction commences.

### BACKGROUND

Various electronic asset trading systems conduct auctions for certain assets, such as government securities, for example, U.S. Treasuries, equities or the like, at, for example, a time that a market opens for trading the assets, or at a specific time period in the day when the market is open. In such auctions, an investor or broker attempts to participate in the auction by transmitting an order for an auction to a computing system, such as an electronic asset trading exchange. One may become a participant in the auction by having the exchange receive an order as of a time that the auction commences, for example, at the time the market opens for trading an asset. Orders that are received before a start of the auction, however, are not accepted for the auction. An entity or individual who submits an order that is received by the computing system as soon as the market open, in other words, one who acts quickly as soon as possible after the market opens to have its order received by the computing system before another order for the auction from another, may obtain a trading advantage. The order of the one would be processed first based on earlier time of receipt, such that in the circumstance that the orders specify the same parameters, such as side, price and size, the order of the one has a greater likelihood of being filled than the another order.

The number of orders for an auction submitted over a communication network, to a computing system operating as a trading exchange and providing an auction functionality, at or slightly after a time that an auction commences, typically can exceed 50,000 orders per second. This very high rate of orders received as data messages at the computing system may cause instability or inoperability of the computing system, and errors in processing or an inability to timely process orders, if the computing system does not have sufficient memory, processing, input/output (TO) interface and bandwidth resources available, or allocatable on demand, to receive and timely process the high influx of orders accurately and at the high speeds of 20-25 microseconds per order typical for fulling orders in an electronic auction. The memory, processing, IO interface and bandwidth resources that need to be available or allocatable on demand to accurately and timely process such large numbers of orders in an auction, however, are very substantial and would greatly increase the cost of a computing system that provides a functionality of electronic trading of assets in an auction.

Accordingly, there exists a need for method, apparatus and system for electronic communication and computing that may provide electronic auction functionalities accurately and timely with reduced memory, processing, IO and bandwidth resource requirements.

### SUMMARY

In accordance with an aspect of the present disclosure, an electronic trading system may include at least one processor configured to control: electronically timing, by an electronic timer, a first time interval, in which the first time interval ends prior to a time that an auction commences; operating in a PreOpen state while the first time interval being timed by the electronic time lr has not elapsed; when operating in the PreOpen state, receiving, over a communication network, from a plurality of computing devices of respective users, orders for the auction, in which each order indicates price, side and size; determining a time stamp for each of the orders corresponding to a time of receipt; and storing, in a memory, each of the orders as bids and offers arranged by price and size in a book; when the first time interval being timed by the electronic timer has elapsed, switching from operating in the PreOpen state to operating in a LockIn state for a second time interval, and electronically timing the second time interval by the electronic timer, in which the second time interval ends prior to the time that the auction commences, and in which when the LockIn state is switched to from the PreOpen state, each order in the book received in the PreOpen state is fixed; when operating in the LockIn state, determining whether at least one order match is possible at top of the book price level tiers of respective bid orders and offer orders in the book; when at least one order match is determined to be possible for the top of the book price level tiers of the book, determining an aggressing side based on a total size of orders at the top of the book price level tiers including at least one order match determined to be possible, determining each aggressing order at each price level tier of the top of the book price level tiers having a possible order match, in best price level tier to worst price level tier order starting from the top of the book price level tier of the aggressing side, in which at least some portion of an aggressing order at a given price level tier is determined to match pro rata with at least some portion of a resting order on a resting side, until an aggressing order at the given price level tier can no longer be determined to match pro rata with a given resting order on the resting side, and in which a pro rata matching size for a first resting order on the resting side is determined based on a size of the first resting order divided by a total order size of the resting side multiplied by a total order size of the aggressing side at the top of the book price level tier; and at the time that the auction commences, atomic matching each given possible order match determined in the LockIn State.

In accordance with an aspect of the present disclosure, a method may include controlling, by at least one processor: electronically timing, by an electronic timer, a first time interval, in which the first time interval ends prior to a time that an auction commences; operating in a PreOpen state while the first time interval being timed by the electronic timer has not elapsed; when operating in the PreOpen state, receiving, over a communication network, from a plurality of computing devices of respective users, orders for the auction, in which each order indicates price, side and size; determining a time stamp for each of the orders corresponding to a time of receipt; and storing, in a memory, each of the orders as bids and offers arranged by price and size in a book; when the first time interval being timed by the electronic timer has elapsed, switching from operating in the PreOpen state to operating in a LockIn state for a second time interval, and electronically timing the second time interval by the electronic timer, in which the second time interval ends prior to the time that the auction commences, and in which when the LockIn state is switched to from the PreOpen state, each order in the book received in the PreOpen state is fixed; when operating in the LockIn state, determining whether at least one order match is possible at top of the book price level tiers of respective bid orders and offer orders in the book; when at least one order match is determined to be possible for the top of the book price level tiers of the book, determining an aggressing side based on a total size of orders at the top of the book price level tiers including at least one order match determined to be possible, determining each aggressing order at each price level tier of the top of the book price level tiers having a possible order match, in best price level tier to worst price level tier order starting from the top of the book price level tier of the aggressing side, in which at least some portion of an aggressing order at a given price level tier is determined to match pro rata with at least some portion of a resting order on a resting side, until an aggressing order at the given price level tier can no longer be determined to match pro rata with a given resting order on the resting side, and in which a pro rata matching size for a first resting order on the resting side is determined based on a size of the first resting order divided by a total order size of the resting side multiplied by a total order size of the aggressing side at the top of the book price level tier; and at the time that the auction commences, atomic matching each given possible order match determined in the LockIn State.

In accordance with an aspect of the present disclosure, a non-transitory storage medium may be configured to store instructions which, when executed by at least one processor, control: electronically timing, by an electronic timer, a first time interval, in which the first time interval ends prior to a time that an auction commences; operating in a PreOpen state while the first time interval being timed by the electronic timer has not elapsed; when operating in the PreOpen state, receiving, over a communication network, from a plurality of computing devices of respective users, orders for the auction, in which each order indicates price, side and size; determining a time stamp for each of the orders corresponding to a time of receipt; and storing, in a memory, each of the orders as bids and offers arranged by price and size in a book; when the first time interval being timed by the electronic timer has elapsed, switching from operating in the PreOpen state to operating in a LockIn state for a second time interval, and electronically timing the second time interval by the electronic timer, in which the second time interval ends prior to the time that the auction commences, and in which when the LockIn state is switched to from the PreOpen state, each order in the book received in the PreOpen state is fixed; when operating in the LockIn state, determining whether at least one order match is possible at top of the book price level tiers of respective bid orders and offer orders in the book; when at least one order match is determined to be possible for the top of the book price level tiers of the book, determining an aggressing side based on a total size of orders at the top of the book price level tiers including at least one order match determined to be possible, determining each aggressing order at each price level tier of the top of the book price level tiers having a possible order match, in best price level tier to worst price level tier order starting from the top of the book price level tier of the aggressing side, in which at least some portion of an aggressing order at a given price level tier is determined to match pro rata with at least some portion of a resting order on a resting side, until an aggressing order at the given price level tier can no longer be determined to match pro rata with a given resting order on the resting side, and in which a pro rata matching size for a first resting order on the resting side is determined based on a size of the first resting order divided by a total order size of the resting side multiplied by a total order size of the aggressing side at the top of the book price level tier; and at the time that the auction commences, atomic matching each given possible order match determined in the LockIn State.

### BRIEF DESCRIPTION OF THE DRAWINGS

FIG. 1 is a block diagram of an exemplary computing apparatus, according to the present disclosure.

FIG. 2 is a block diagram of an exemplary system, according to the present disclosure.

FIGS. 3A and 3B illustrate an exemplary high level flow diagram of an exemplary method of conducting an auction, according to the present disclosure.

FIG. 4A and 4B illustrate an exemplary high level flow diagram of an exemplary method of determining possible order matches, according to the present disclosure.

FIGS. 5A, 5B, 5C and 5D illustrate an exemplary implementation of the method of conducting an auction, according to the present disclosure.

FIGS. 6A, 6B, 6C and 6D illustrate an exemplary implementation of the method of conducting an auction, according to the present disclosure.

FIGS. 7A, 7B and 7C illustrate an exemplary implementation of the method of conducting an auction, according to the present disclosure.

FIGS. 8A, 8B and 8C illustrate an exemplary implementation of the method of conducting an auction, according to the present disclosure.

FIGS. 9A, 9B and 9C illustrate an exemplary implementation of the method of conducting an auction, according to the present disclosure.

### DETAILED DESCRIPTION

The technology of the present disclosure relates to, by way of example, a computer and networking architecture that may control determining possible order matches of orders for an auction in an order book received prior to a time that an auction commences, by price and size of the orders and pro rata matching of orders at top of the book price level tiers, in best price level tier to worst price level tier order starting from the top of the book price level tier, and atomic matching of the possible order matches at the time that the auction commences. Advantageously, determining possible order matches before the time that an auction commences (“PreOpen matching”), and atomic matching the orders matched by PreOpen matching at the time that the auction commences according to the present disclosure, reduces computing system and network resources, including memory, processing, IO interface and bandwidth, and costs to obtain or allocate the resources necessary to ensure that timely and accurate processing of orders for auction submitted to a computing system that provides electronic auction functionalities.

In one exemplary embodiment, a computing system as an asset trading platform may include an auction functionality that implements an auction of assets, such as, for example, a bond, an equity or a repurchase agreement (“repo”). A repo is a short-term agreement in which, for example, a dealer sells securities to an investor at a first price and interest rate for a fixed time period, such as overnight, and buys the securities back from the investor at a slightly higher price than the first price in accordance with the interest rate. In one embodiment, the computing system may control receiving orders for an auction before a time that the auction commences, where the orders are for trading an asset; determining possible order matches at top of the book price level tiers of an order book containing the received orders, in best price level tier to worst price level tier order starting from the top of the book price level tiers, where possible order matches are determined by price, size and a pro rata matching process that maximizes spreading fills between or among resting orders on a resting side of the order book; and atomic matching the possible order matches at the time that the auction commences.

It is to be understood that the features in accordance with the present disclosure may be applied to an auction for any type of asset, such as, for example, event ticketing auctions, such as for entertainment events or transport carrier (airline, train, etc.) seat ticketing, or in any auction like setting, to reduce memory, processing, IO interface and bandwidth resource requirements and associated costs for allocating or obtaining the necessary memory, processing, IO interface and bandwidth resources.

The present disclosure may be implemented using a combination of computer hardware and computer software to form a specialized machine capable of performing operations. Embodiments of the present disclosure may be performed utilizing a combination of central processing units (CPUs), physical memory, physical storage, electronic communication ports, electronic communication lines and other computer hardware. The computer software may include at least a computer operating system and specialized computer processes described herein.

In the present disclosure, certain specific details are set forth to provide a thorough understanding of various disclosed embodiments. However, one skilled in the relevant art will recognize that embodiments may be practiced without one or more of these specific details, or with other methods, components, etc. In other instances, well-known structures associated with an electronic trading system have not been shown or described in detail to avoid unnecessarily obscuring descriptions of the embodiments.

The aspects, features and advantages of the present disclosure will be appreciated when considered with reference to the following description of examples and accompanying figures. In describing the exemplary embodiments of the disclosure illustrated in the drawings, specific terminology will be used for the sake of clarity. However, the disclosure is not intended to be limited to the specific terms used.

### Example Systems

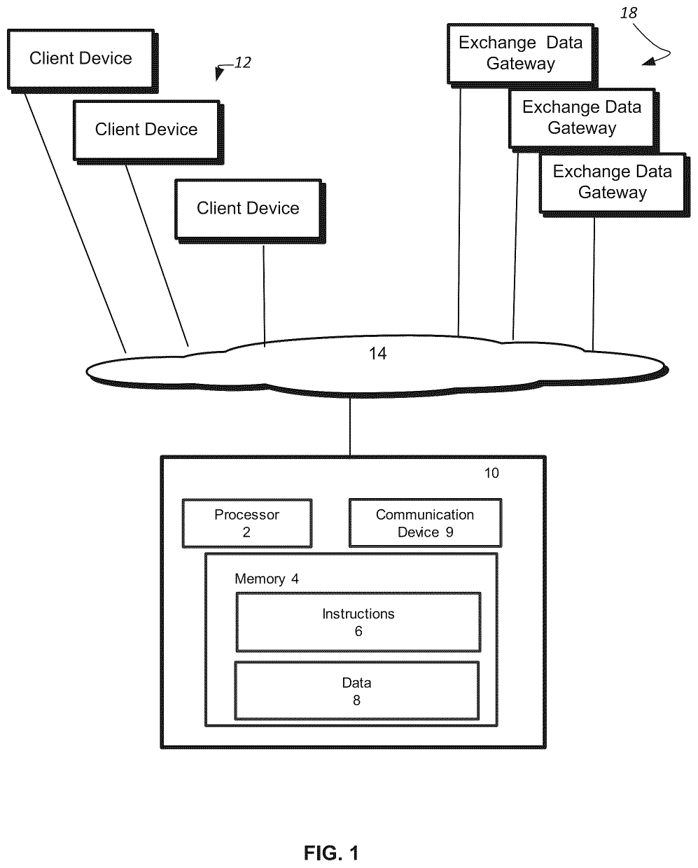

FIG. 1 illustrates a block diagram of an exemplary computing apparatus 10, in accordance with the present disclosure. The apparatus 10 may be communicatively coupled, over a communication network 14, with a plurality of computing devices 12 as client devices that are data sources, and a plurality of computing devices 18 as exchange data gateways that are data destinations. The computing devices 12 may be computing devices at which an order to trade an asset in an auction, for example, an order to buy or sell a U.S. Treasury or a repo at an auction, may be entered or generated automatically, and may transmit orders in respective order messages to the apparatus 10. The computing devices 14 may be exchange data gateways that include or operate in conjunction with an electronic asset trading exchange to execute trades of matched orders in an auction, based on order match information provided from the apparatus 10.

In some embodiments, advantageously according to the present disclosure, the apparatus 10 may control maximizing spreading fills between or among orders for an auction in a book of orders received prior to a time that the auction is commenced, by determining possible order matches in the book by price, size and a pro rata matching process, to facilitate receiving, processing and matching orders for an auction that minimizes usage of network bandwidth, processing, memory, IO interface and bandwidth resources, as described in detail below.

Referring to FIG. 1, the computing apparatus 10 may be in the form of a computing device that includes one or more processors 2, one or more memory 4, and other components commonly found in computing devices. In one embodiment, the one or more processors 2 may include or be configured to operate as one or more servers.

The memory 4 may store information accessible by the one or more processors 2, including instructions 6 that may be executed by the one or more processors 2.

The one or more processors 2 may include an architecture configured to include a programmable hardware device, such as a field programmable field array (“FPGA”), an application specific integrated circuit (“ASIC”) or system on chip (“SoCs”). In one embodiment, the architecture may be hardwired on a substrate. In one embodiment, the one or more processors 2 may be any type of processor, such as a CPUs from Intel, AMD, and Apple.

Memory 4 may also include data 8 that can be stored, manipulated or retrieved by the processor. The data 8 may also be used for executing the instructions 6 and/or for performing other functions. The memory 4 may be any type of non-transitory media readable by the one or more processors, such as a hard-drive, solid state hard-drive, memory card, ROM, RAM, DVD, CD-ROM, write-capable, read-only memories, etc.

The instructions 6 may be any set of instructions capable of being read and executed by the one or more processors 2. The instructions may be stored in a location separate from the computing device, such as in a network attached storage drive, or locally at the computing device. The terms “instructions,” “functions,” “application,” “steps,” and “programs” may be used interchangeably herein. The instructions residing in a non-transitory memory may comprise any set of instructions to be executed directly (such as machine code) or indirectly (such as scripts) by processor 2. In this regard, the terms “instructions,” “scripts,” or “modules” may be used interchangeably herein. The computer executable instructions may be stored in any computer language or format, such as in object code or modules of source code. Furthermore, it is understood that the instructions may be implemented in the form of hardware, software, or a combination of hardware and software and that the examples herein are merely illustrative.

Data 8 may be stored, retrieved and/or modified by the one or more processors 2 in accordance with the instructions 6. Such data may be stored in one or more formats or structures, such as in a relational or non-relational database, in a SQL database, as a table having many different fields and records, XLS, TXT, or XML documents. The data may also be formatted in any computing device-readable format. In some embodiments the data may be encrypted.

The apparatus 10 may include a communication device 9 configured to provide wired or wireless communication capabilities.

The communication network 14 may be a local area network (“LAN”), a wide area network (“WAN”), or the Internet, etc. The communication network 14 and intervening nodes thereof may use various protocols including virtual private networks, local Ethernet networks, private networks using communication protocols proprietary to one or more companies, cellular and wireless networks, HTTP, and various combinations of the foregoing. In addition, the network 14 may utilize a variety of networking protocols now available or later developed including, but not limited to, TCP/IP based networking protocols.

In one embodiment, the computing apparatus 10 may include the communication network 14 and at least a portion of the computing devices 12 or the computing devices 18.

FIG. 1 illustrates the components of the apparatus 10 as being single components, however, the components may comprise multiple programmable hardware devices such as FPGAs, processors, computers, computing devices, or memories that may or may not be stored within the same physical housing. For example, the memory may be a hard drive or other storage media located in housings different from that of the apparatus 10. Accordingly, references to a programmable hardware device, processor, computer, computing device, or memory herein will be understood to include references to a collection of processors, computers, computing devices, or memories that may or may not operate in parallel. Further, although some functions described below are indicated as taking place on a single computing device having a single processor, various aspects of the subject matter described herein may be implemented by a plurality of computing devices in series or in parallel. For example, in one embodiment, functions performed by the apparatus 10 as described below may at least be partially performed at another computing apparatus having the same or similar components as the apparatus 10. In one embodiment, functions described herein as performed by the apparatus 10 may be distributed among one or more computing devices (servers) that operate as a cloud system.

Although only a single computing apparatus 10 (computer) is depicted herein it should be appreciated that a computing apparatus in accordance with the present disclosure may include additional interconnected computers and programmable hardware devices. It should further be appreciated that apparatus 10 may be an individual node in a network containing a larger number of computers.

In one embodiment, the apparatus 10 may include all the components normally used in connection with a computer. For example, the apparatus 10 may have a keyboard and mouse and/or various other types of input devices such as pen-inputs, joysticks, buttons, touch screens, etc., as well as a display, which could include, for instance, a CRT, LCD, plasma screen monitor, TV, projector, etc.

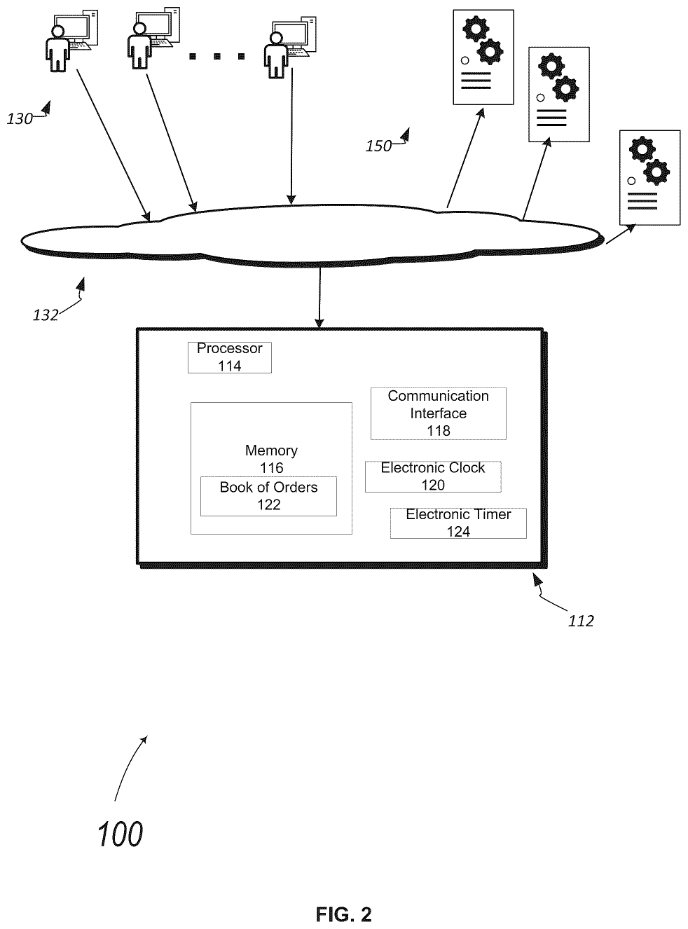

Referring to FIG. 2, in some embodiments, the apparatus 10 may be configured as a system 100 to implement specific functions and operations in accordance with the present disclosure. In some embodiments, the system 100 may be programmed with programs to perform some or all of the functions and operations described herein.

Referring to FIG. 2, the system 100 may include a server 112 including a processor 114, a memory 116, a communication interface 118, an electronic clock 120 and an electronic timer 124. The memory 116 may be configured to store instructions to implement specific functions and operations, and data related to order receipt, processing and matching in an auction, in accordance with the present disclosure. In one embodiment, the memory 116 may include a book of orders 122 portion that stores orders for an auction received by the server 112.

In one embodiment, the processor 114 may monitor and control time of the electronic clock 120, and the electronic clock 120 may indicate time at increments of nanoseconds.

In one embodiment, the processor 114 may monitor timing by, and control operation of, the electronic timer 124, and the electronic timer124 may indicate time at increments of nanoseconds.

In one embodiment, the memory 116 may be configured to store order data indicating orders received, and a time of the electronic clock 120 when each order is received, at the server 112. In one embodiment, the orders may be stored in a book configuration in the book of orders 122 of the memory 116, where bid orders are on one side and offer orders are opposite the bid orders, and where each order has a size and price and is identified by a user that submitted the order. In one embodiment, the user may be a computing device that implements an algorithm that automatically generates and transmits an order for auction. In one embodiment, the user may be a human that directly or indirectly provides input information of an order to a computing device to cause the computing device to transmit an order for auction.

In one embodiment, each of the components of the system 100 may include a processor and a memory including instructions that implement functions of the respective component, as described below.

Computing devices 130, such as client devices at which orders for an auction may be manually input or automatically generated by a processor thereof, may be configured to transmit orders for an auction, over a communication network 132, to the server 112. In one embodiment, the system 100 may include at least a portion of at least one of the computing devices 130 and at least a portion of the communication network 132. In one embodiment, the computing device 130 may include a TCP circuit that transmits order data in an order message containing one or more data packets forming the order data.

The processor 114 may be configured to extract order data of an order contained in an order message received from a computing device 130, and determine a time stamp for the order as a time of the electronic clock 120 when the order data for the order, such as in a TCP message, is received at the server 112. The processor 114 may be configured to, for each order received, store the order data thereof, which includes identity of a user that entered the order, side (buy or sell) of the order, price of the order and size of the order, associated with the time stamp thereof, in the memory 116, such as in the book of orders 122.

In one embodiment, the orders may be stored in the book of orders 122 arranged by a user that submitted the order, and side, price and size of the order. For example, the orders of users A, B, C, D, E and F may be stored in an arrangement as shown in Table 1 below, where orders are arranged in best price to worst price order, from the top row to a bottom row of a column, and orders having the same price are arranged in descending size order in a column.

TABLE 1

| Bid User | Bid Price | Bid Size | Offer Size | Offer Price | Offer User |
|---|---|---|---|---|---|
| D | 0.5 | 100 | 300 | 0.5 | A |
| E | 0.5 | 100 | 150 | 0.5 | B |
| F | 0.5 | 50 | 50 | 0.5 | C |

In one embodiment, the orders on each side for a same or type of asset, for example, a repo for a U.S. Treasury bond, may be arranged in a book in best price level to worst price level order, where an order at the best price level tier on a side, or the top of the book on the side, is at a first (highest) row of the column.

In addition, the processor 114 may be configured to control the electronic timer 124 to time a first time interval of a PreOpen state. The first time interval of the PreOpen state is a time interval prior to a time that an auction commences. In the PreOpen state, the processor 114 may receive and process orders for an auction, and store the orders in a book form in the book of orders 122 as described above for Table 1. Also, the processor 114 may be configured to control the electronic timer 124 to time a second time interval of a LockIn state. The second time interval of the LockIn state is a time that starts after the first time interval elapses and ends prior to a time that the auction commences. The second time interval of the LockIn state may, for example, be a few milliseconds or not more than about 1 second. In one embodiment, the processor 114 may control switching of operation of the server 112 from operating in the PreOpen state to operating in the LockIn state when the first time interval elapses, where timing of the second time interval begins when the first time interval elapses. Each order in the book at the time the PreOpen state has elapsed becomes a fixed order for which a possible order match with another order in the book may be determined during the LockIn state. In one embodiment, the second time interval may elapse about a few microseconds before a time that the auction commences. For convenience, reference below to during the PreOpen state or during the LockIn state means at a time the server 112 is operating in the PreOpen state or LockIn state, respectively.

The processor 114 may only accept an order for auction received during the PreOpen state, such that an order for auction received during the LockIn state is not accepted and, thus, not considered for determining a possible order match for the auction.

Further, the processor 114 may be configured to control, when operating in the LockIn state, determining a possible order match(es) at price level tiers at the top of the book of orders; and when at least one possible order match is determined, determining (i) an aggressing side at the top of the book price level tiers and (ii) whether an order match is possible for an aggressing order at a price level tier of the aggressing side, in best price level tier to worst price level tier order starting from the top of the book price level tier of the aggressing side. In one embodiment, a size of an order determined for a possible order match may be determined based on a pro rata matching process, in which possible matches of some portion of an aggressing order at a given price level tier with at least some portion of a resting order on a resting side are determined, until some unmatched portion of an aggressing order at the given price level tier can no longer be determined to match pro rata with some unmatched portion of a given resting order on the resting side. In one embodiment, the operations performed by the processor 114 during the Lockin state are only for those orders in the book at the time the PreOpen state has elapsed. In one embodiment, the processor 114 may be configured to control, after the LockIn state ends and at the time that the auction commences, for each possible order match determined in the LockIn state, atomic matching at a trading exchange some portion of a given aggressing order that is a size of a pro rata matching size of a given resting order.

In one embodiment, for each order received during or after the LockIn state, such order is processed after an auction commences and atomic matching has been completed for the possible order matches determined from orders received during the PreOpen state.

In one embodiment, the server 112 may transmit an order matching message including details of all possible order matches determined during the LockIn state over the communication network 132 to one or more computing devices 150 as exchange gateways or trading exchanges, to facilitate execution of all possible order matches in an atomic match.

In one embodiment, the order matching message may be transmitted as a TCP message from a TCP server circuit (not shown) of the computing system 100.

In one embodiment, the processor 114 may be configured to control, after the time that the auction commences and while the auction is ongoing, i.e., when a market is open to process portions of any order for the auction not identified as forming a possible order match during the LockIn state, and following the atomic matching, attempting to match a remaining unmatched or partially filled portion of the order from the book at a trading exchange.

In one embodiment, the processor 114 may control selective communication and display of order information of orders in the book to a computing device 130 during operation in the PreOpen state. In one embodiment, the processor may control display, at a given computing device 130, of only those orders whose source is the given computing device 130 or a user of the given computing device, and prevent display or notification at the given computing device of any order submitted from other than the user of the given computing device or the given computing device.

In one embodiment, the processor 114 may control, during the LockIn state, notifying, such by an alert notification transmitted over the communication network 132, and rendering of an alert, such by a video or audio rendering, at the computing device 130, that a change to an existing order or submission of a new order is not permissible and will not be considered during the LockIn state.

For ease of reference and convenience, the disclosure herein that the server 112 or another component of the system 100 may perform a function or operation, is a disclosure that a processor or circuitry of the server 112 or the another component of the system 100 may perform or control the performance of the function or operation.

In one embodiment, one or more of the computing devices 130 may be a laptop, desktop or mobile computing device, such as a smartphone or tablet. The one or more client devices may execute an “app” to interact with the server 112. The app, for example, may execute on a mobile device operating system, such as Apple Inc.'s iOS®, Google Inc.'s Android®, or Microsoft Inc.'s Windows 10 Mobile®, which provides a platform that allows the app to communicate with particular hardware and software components of the mobile device. For example, the mobile device operating system may provide functionalities for interacting with location services circuitry, wired and wireless network interfaces, user contacts, and other applications, where the functionalities include application programming interfaces (APIs) that enable communication with hardware and software modules executing outside of the app, such as included in the system 100. In one embodiment, the computing device 130 may, via the app executing on the computing device 130, be configured to communicate with the server 112 via the communication interface 118.

In one embodiment, one or more of the computing devices 150 may be, for example, a financial venue, an exchange or a matching engine.

In one embodiment, a network path between the server 112 and a computing device 130 or 150 may be configured to facilitate communication using a Point to Point Financial Information eXchange (FIX) protocol, or any other protocol.

### Example Methods

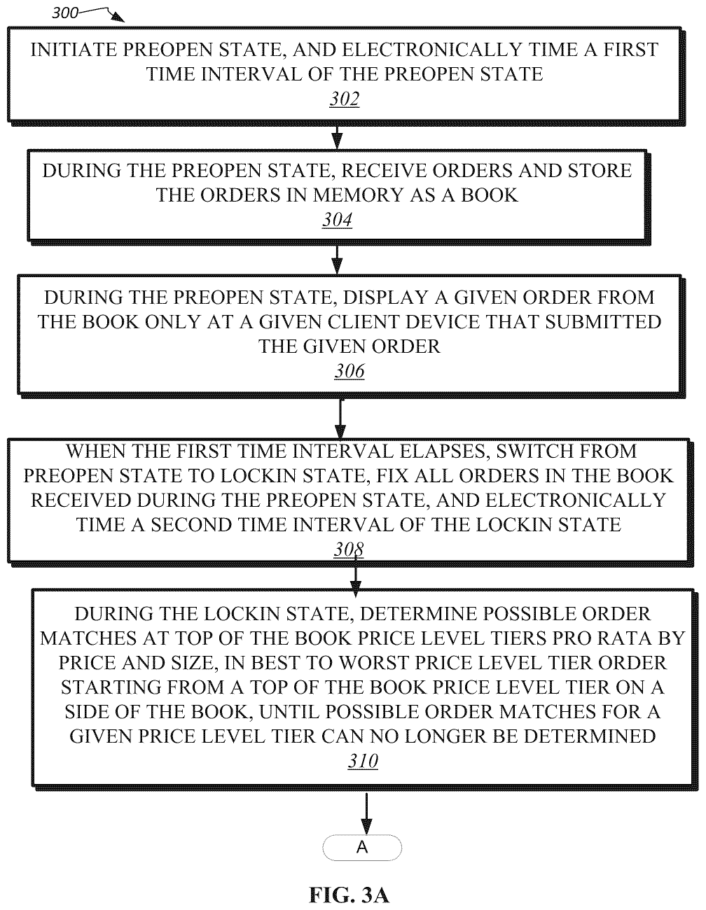

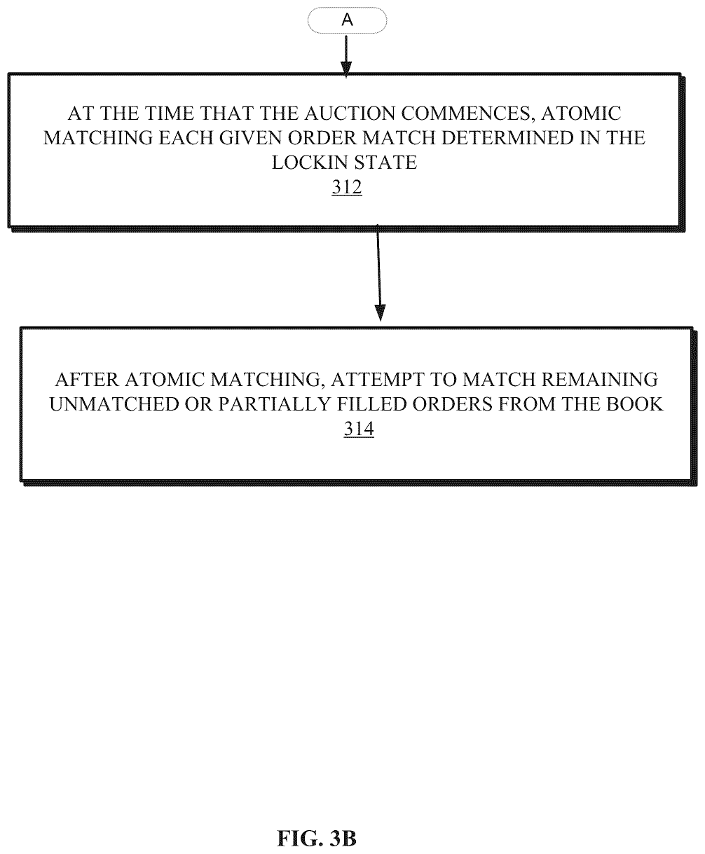

For purposes of illustrating the features of the present disclosure, a high level block diagram of an exemplary process 300, as shown in FIGS. 3A and 3B, which, prior to a time that an auction commences, determines possible order matches for an auction by price, size and a pro rata matching process that maximizes spreading fills between or among orders at a top of an order book, and at a time that the auction commences atomic matches the possible order matches, to reduce the processing, memory, IO interface and bandwidth resources that need to be obtained or allocated to facilitate order matching in an auction of assets, is described below in connection with operations performed at components of the computing system 100 as shown in FIG. 2.

For purposes of illustrating features of the process 300 in conjunction with the functions performed by the system 100, an exemplary implementation of determining possible order matches of orders for repos prior to a time that an auction commences therefor, and atomic matching the possible order matches at the time that the auction commences, is described below.

Referring to FIGS. 3A-3B, in block 302, the processor 114 may control the system 100 to operate in a PreOpen state, prior to a time that an auction for repos commences. At the time the processor 114 initiates operation in the PreOpen state, the processor 114 may start timing a first time interval by the electronic timer 124. During the PreOpen state, the processor 114 may monitor timing by the electronic timer 124 of the first time interval, and determine when the first time interval elapses.

In block 304, during the PreOpen state, the processor 114 may receive order messages from computing devices 130 over the communication network 132. The order messages may contain order data of an order(s) for auction including, for example, user identification information, and size, price and side of the order. The processor 114 may determine, for each order received, a time stamp which is a time of the electronic clock 120 when the order message containing the order is received at the server 112. In addition, the processor 114, for each order received, may store in the memory 116 order data of the order with the time stamp corresponding thereto. In one embodiment, the processor 114 may store, in the book of orders 122 portion of the memory 116, the orders received as a book of orders having a format the same as or similar to that described above with reference to Table 1.

In one embodiment, a computing device 130 may transmit a TCP message containing order data of an order.

In block 306, during the PreOpen state, the processor 114 may transmit, over the communication network 132, to a specific computing device 130, display information indicating only orders currently in the book whose source is the specific computing device 130, or a specific user of the computing device 130, to cause display of the display information at the specific computing device. In one embodiment, order data of orders of other users are prevented from being transmitted to a specific computing device 130 that is not a source of the order data.

In addition, during the PreOpen state, a user, via a computing device 130, may submit as many orders as the user desires, and the processor 114 may receive and include each order received from the user in the book.

In one embodiment, a user may transmit order change data to, for example, modify or cancel an order previously submitted during the PreOpen state. As long as the order change data is received by the system 100 during the PreOpen state, the processor 114 may revise or cancel an order in the book based on the order change data. In one embodiment, the time stamp of an order may not be changed when the order is modified based on order change data.

In block 308, when the processor 114 determines from the electronic timer 124 that the first time interval being timed has elapsed, the processor 114 may switch operation of the system 100 from the PreOpen state to operation in the LockIn state. When operation is switched from the PreOpen state to the LockIn state, all orders in the book become fixed and no further orders may be added to the book. All orders in the book when the PreOpen state ends may be considered for possible order matching during the LockIn state, in accordance with present disclosure.

In one embodiment, when operation of the system 100 switches from the PreOpen state to the LockIn state, the processor 114 may transmit, over the communication network 132, an auction open notification to each of the computing devices 130 indicating that order data of a new order or order change data will be processed by the system 100. At the time operation of the system 100 is switched to the LockIn state, the processor 114 may cause the electronic timer 124 to start timing a second time interval, which is a time length that the system 100 may operate in the LockIn state. In one embodiment, the second time interval may be configured and timed following the end of the PreOpen state, to provide that the LockIn state ends prior to the time that the auction commences.

In block 310, during the LockIn state, the processor 114 may determine possible order matches of orders at top of the book price level tiers. In one embodiment, advantageously, the possible order matches may be determined by a PreOpen matching process that maximizes spreading fills between or among orders at the top of a book of orders, such that the number of orders remaining unfilled at the top of the book, following an atomic matching of the possible order matches at the time that the auction commences as discussed in detail below in block 312, is minimized.

The technology of the present disclosure including a PreOpen matching processing, which determines possible order matches prior to a time that an auction commences, and filling the possible order matches by atomic matching at a trading exchange at the time that the auction commences, solves the technical problems of an electronic auction accurately receiving and processing a large number of orders for auction at the time that an auction commences.

In conventional electronic auction implementations in which orders for an auction are received and processed only at or after the time that an auction commences, technical problems exist in accurately and timely receiving and processing the orders, which requires substantial processing, memory, IO interface and bandwidth resources to be available or allocated, which in turn increases electronic auction platform implementation costs. Without having substantial processing, memory, IO interface and bandwidth resources available or allocatable for use to receive and process orders for an auction starting from the time that an auction commences, a computing platform that serves as an electronic auction platform is susceptible to instability and data processing disruptions and errors. In these electronic auction platform implementations, a substantial amount of data of about 10,000 orders in the form order messages from about 65-80 order sources typically is received within a very small time period, for example, in one second. Such high order reception rate, in turn, requires substantial bandwidth capacity, for example, a 10 gigahertz capable network card, and many IO interface ports, for example, about 100-200 ports, to be available or allocatable, to ensure that all orders in the order messages are accurately received and a data bottleneck, which results in some of the orders not being received, is not created at hardware inputs of a computing system providing the electronic auction platform functionality. In the event sufficient resources are not allocatable or available, some order messages, and thus the orders thereof, may not be received, or may be received incompletely, such that an order is not timely processed at the time that the auction commences, or is not processed at all for inclusion in the auction. For example, when the resources are insufficient, the order message may be corrupted such that certain order parameters, such as size, price or side of the order, may not be determinable, or the order message may be received but not saved in memory because temporary buffers that store order messages before processing is performed to extract and store in the memory the order data thereof are overflowing or filled. In addition, when the resources are insufficient, an accurate time of receipt of order messages may not be determined, such that the order of an order message may not be processed for matching in an auction based on an actual time of receipt thereof at a computing system. For example, an order A received prior to order B may be processed for matching after the order B, because an inaccurate time of receipt is determined for the order A which is after the time of receipt determined for the order B.

Advantageously, the technology of the present disclosure reduces bandwidth and IO interface resources requirements for an electronic asset auction. The need to receive and process a large volume of data in a very short time interval is eliminated, in that order messages containing orders may be received over a longer time interval, such as hours, during a PreOpen state before the time that an auction commences. The technology of the present disclosure avoids the creation of an IO bottleneck, which can be caused based on the need to write a large amount of data in memory over a short time interval. Also, the technology of the present disclosure advantageously reduces processing and memory resource requirements, because there is no longer a need to process many order messages quickly and immediately upon receipt in a very short time interval, for example, processing all of about 50,000 orders received as order messages at the time that an auction commences in one second. Further, the technology of the present disclosure reduces the potential for jitter errors that occur at high processing speeds that a processor would need to operate to process all orders received at the start of an auction within a very short time interval. In addition, the technology of the present disclosure provides high availability of a computing system to perform other operations and avoids disconnects, and furthermore guarantees filling portions of orders forming possible order matches determined from a PreOpen matching process at the time that an auction commences.

Thus, the technology of the present disclosure constitutes a technical solution to a technical problem that matches orders for auction in an electronic auction at the time that an auction commences at a desired low latency in processing, with high accuracy and with a reduction of the processing, memory, IO and bandwidth resources that need to be obtained or allocated.

In one embodiment, in block 310, a PreOpen matching process may include, during the Lockln state, the processor 114 determining possible order matches of orders at top of the book price level tiers pro rata by price and size, in best price level tier to worst price level tier order starting from the top of the book price level tier on a side of the book, until possible order matches for a given price level tier can no longer be determined.

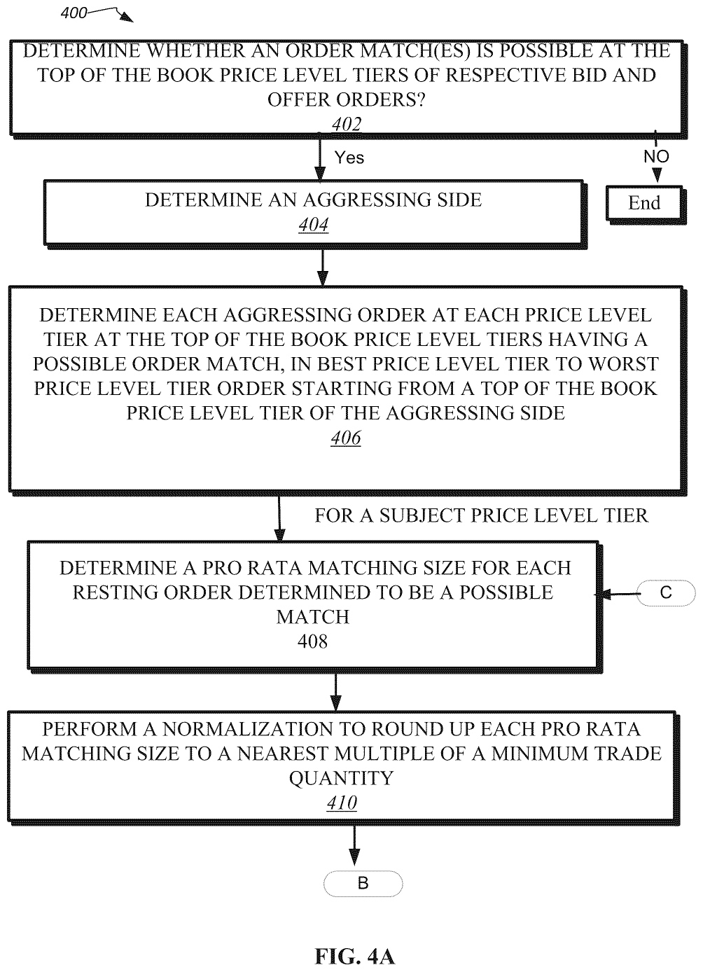

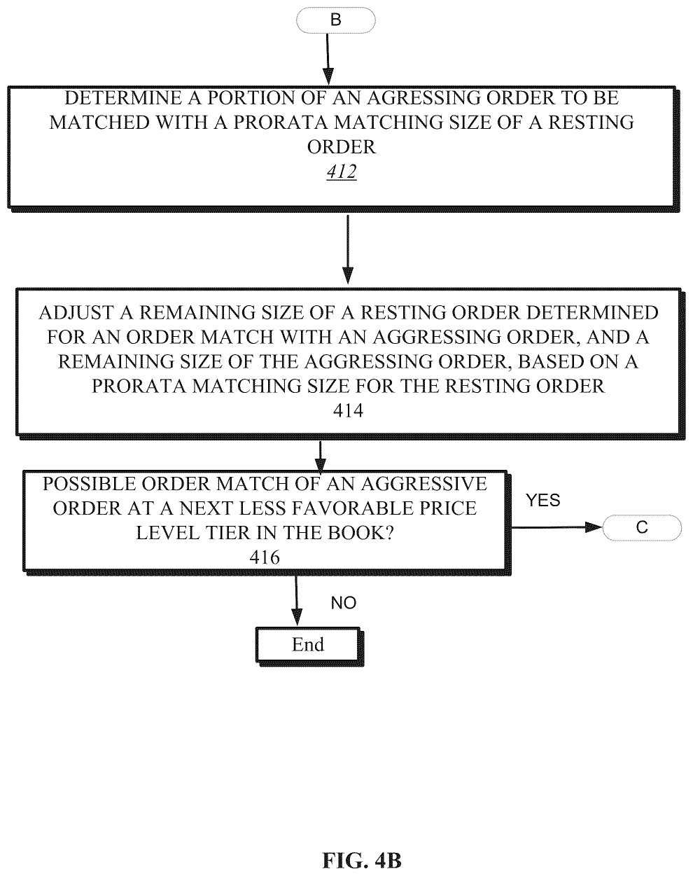

FIGS. 4A-4B illustrate an exemplary embodiment of a PreOpen matching process 400 that may implement block 310.

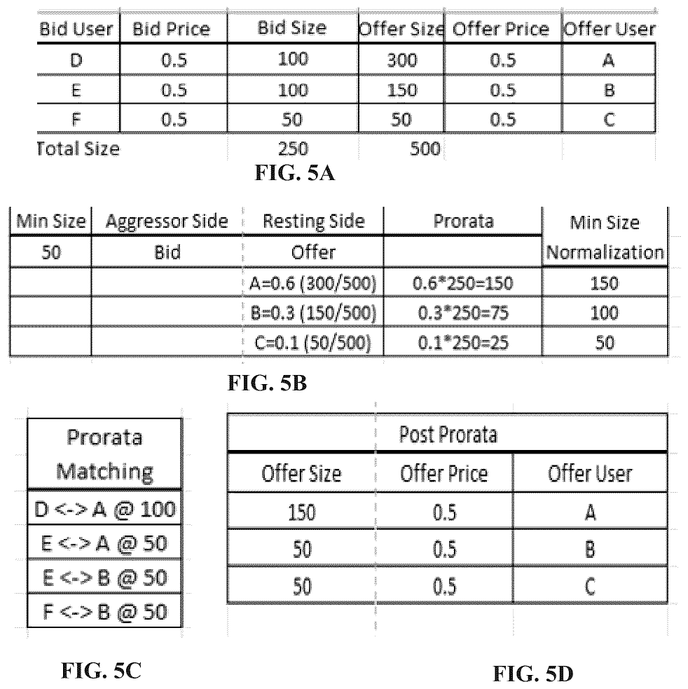

Referring to FIGS. 4A-4B, in block 402, the processor 114 may determine whether an order match is possible at top of the book price level tiers of respective bid orders and offer orders in a book. For purposes of illustrating features of the process 400 according to the present disclosure, reference is made to an example book of orders for repo as shown in FIGS. 5A-5D.

Referring to FIG. 5A, the top of a book of orders for repo may include offer orders from users A, B and C respectively having offer sizes 300, 150 and 50, where each offer order has an offer price of 0.5% interest, and bid orders from users D, E and F respectively having bid sizes 100, 100 and 50, where each bid order has a bid price of 0.5% interest. The bid price of 0.5% interest and the offer price of 0.5% interest each constitute a top of the book price level tier on a respective side of the book. The processor 114 would, for example, determine that an order match is possible between the offer order of the user A, which is a best price level tier at a top of the book price level tier on the offer side, and the bid order of the user D, which is a best price level tier at a top of the book price level tier on the bid side.

In the event the processor 114 determines an order match is possible at top of the book price level tiers of respective bid orders and offer orders in a book, the processor 114 may determine whether additional order matches are possible at top of the book price level tiers of respective bid orders and offer orders in a book. Referring to FIG. 5A, the processor 114 would determine whether there are other possible order matches for bid users E and F and offer users B and C at top of the book price level tiers, and determine that order matches are possible for users B and C with users D, E and F, and users E and F with users A, B and C.

In the event the processor 114 does not determine an order match is possible at top of the book price level tiers of respective bid orders and offer orders in a book, the processor 114 may cease the PreOpen matching process for a subject book of orders.

In block 404, when at least one possible order match is determined in block 402, the processor 114 may determine an aggressing side of the book based on the orders at the top of the book price tier levels for which possible order matchers are determined. In one embodiment, when total order sizes respectively of bid and offer sides of orders determined to be possible to match are the same, the aggressing side may be a side that first received an order that is determined to be possible to match. In one embodiment, when total order sizes respectively of bid and offer sides of orders determined to be possible to match are different, the aggressing side may be a side having the smaller total order size. Referring to FIG. 5A, the processor 114 would determine that the total bid size 250 is smaller than the total offer size 500, such that the bid side is the aggressing side and the opposite side of the offer side is the passive or resting side.

In block 406, the processor 114 may determine each aggressing order on an aggressing side, at each price level tier of the top of the book price level tiers, having a possible order match with a resting order of the resting side of the book, in best price level tier to worst price level tier, starting from the top of the book price level tier of the aggressing side. Referring to FIG. 5A, where the bid side is the aggressing side, the aggressing orders of each of users D, E and F may be determined to have a possible match with the resting orders of each of users A, B and C, where the orders of users D, E and F and the orders of user A, B and C respectively are in best price level tiers on the aggressing and resting sides. In this example, there is a single top level price tier on each of the aggressing and resting sides.

In block 408, for a subject price level tier on the aggressing side determined to have a possible order match in block 406, the processor 114 may determine a pro rata matching size of a resting order for each aggressive order of the subject price level. Referring to FIG. 5A, a pro rata matching size of a resting order would be determined for orders of each of users D, E and F, which are all of the best price level tier on the aggressing side. The processor 114 may determine a pro rata matching size of a resting order for a possible match for the subject price level tier by the following computation: a total size of the aggressing order(s) at a best price level tier on the aggressing side multiplied by a size of a given resting order to be matched divided by a total size of resting orders determined to have possible matches at the best price level tier. Referring to FIG. a pro rata matching size for the resting order of user A is computed as (250)(300)/500 or 150, where the size of the resting order of user A is 300, the total size of the resting orders determined to have possible matches at the best price level tier is 500 and the total size of aggressing orders at the best price level tier on the aggressing side is 250. Similarly, pro rata matching sizes for resting orders of users B and C, which are in the same price level tier as the order of user A and were determined to be possible matches of the best price level tier of 0.5% interest on the bid side, which include bid orders of users D, E and F, are computed as shown in FIG. 5B.

In block 410, the processor 114 may normalize the pro rata matching sizes determined in block 408 by rounding up to a nearest multiple of a minimum trade quantity for an asset. For example, where the minimum trade quantity is 50, and referring to FIG. 5B, normalization may adjust the pro rata matching sizes of 150, 75 and 25 of users A, B and C to become pro rata matching sizes of 150, 100 and 50, respectively. It is to be understood that normalization may not be performed where a result of normalization results in a pro rata matching size greater than the current size of the corresponding order.

In block 412, the processor 114 may determine a portion of an aggressing order to be matched with a pro rata matching size of a resting order. Referring to FIG. 5C, in sequence, a size 100 of user A's order is identified for a match with the entirety of the size 100 of user D's order; a size 50 of user A's order is identified for a match with a size 50 of user E's order; a size 50 of user B's order is identified for a match with a size 50 of user E's order, which fills the entirety of E's order; and a size 50 of user B's order is identified for a match with the size 50 of user F's order, which fills the entirety of F's order.

In block 414, the processor 114 may adjust a remaining unfilled size of a resting order for which a pro rata matching size is determined, and a remaining unfilled size of an aggressing order to which the resting order is determined for a possible order match. Referring to FIG. 5D, the possible order matches determined from the PreOpen matching process reduce the size of user A's order from 300 to 150 and user B's order from 150 to 50, and the unfilled size of user C's order remains unchanged. Based on the possible order matches, the entireties of user D's, E's and F's orders are completely filled.

In block 416, the processor 114 may determine whether a possible order match was determined at a next less favorable price level tier on the aggressing side. If yes, blocks 408, 410, 412 and 414 are performed again. If no, processing resumes from block 312 of the process 300.

In block 312, the processor 114 may determine that the second time interval being timed has elapsed, and await a time that the auction commences.

In one embodiment, the processor 114 may continuously perform the operations of block 310, to determine all possible order matches by the PreOpen matching process before the Lockln state elapses and the time that the auction commences.

When the processor 114 determines that the time that the auction commences is reached, the processor 114 may transmit, over the communication network 132, to a computing device 150 as a trading exchange, an auction match message indicating instructions to atomic match all of the possible order matches determined during the Lockln state, according to the pro rata matching sizes of resting orders determined for a respective matched aggressing order. Advantageously, as discussed above, the atomic matching of all of the possible order matches determined during the PreOpen matching process eliminates the need to obtain and/or allocate computing hardware, software and network resources to process, store, receive and transmit data to match accurately and quickly in an auction orders for an auction that can only be received at a time that the auction commences or thereafter. In one embodiment, the auction match message may be a TCP message.

In one embodiment, the server 112 and the computing device 150 as a trading exchange may be in a same computing system.

In block 314, the processor 114 may attempt to match any remaining unmatched or partially filled orders from the book. In one embodiment, the processor 114 may transmit, over the communication network 132, to a computing device 150 as a trading exchange, an unfilled order message indicating details of orders in the book that are unfilled, following atomic matching. The atomic matching of possible order matches determined during the PreOpen matching process, which determines possible order matches by spreading fills of orders between or among orders at the top of the book price level tiers, advantageously reduces the computing hardware, software and network resources that would need to be obtained or allocated to facilitate filling partially filled orders that remain following atomic matching. More orders are likely to be completely filled after atomic matching based on the pro rata matching of the PreOpen matching process, and building an order book of possible order matches before an auction commences reduces the processing load on a computing system and overall results in a more streamlined matching experience for users while lowering the chances of the computing system experiencing a jitter due to an extremely high processing load in a very short amount of time.

Thus, referring to FIGS. 5A and 5D, after atomic matching the possible order matches determined during the PreOpen matching process, the system 100 may require reduced memory, processing and network resources to process orders because the entirety of user D's, E's and F's orders have been filled, and the users A and B would have orders remaining of reduced size, namely 150 and 50 respectively, relative to the original sizes of 300 and 150. Furthermore, the reduction in the size of individual orders would permit the remaining size of an unfilled order of a particular user to be filled completely more readily, thus further reducing the memory, processing, IO interface and network resources that the system 100 would require to facilitate matching of orders for auction following atomic matching of the possible order matches at the time that the auction commences.

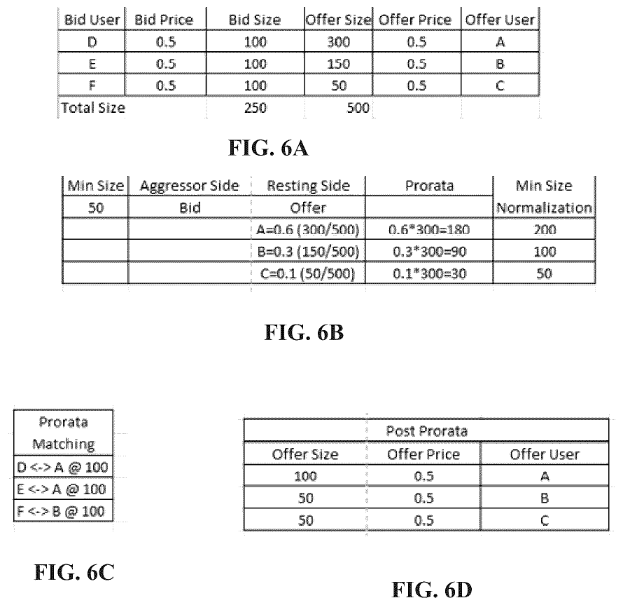

Referring to FIGS. 6A, 6B, 6C and 6D, an exemplary implementation of the process 400 to facilitate an auction including a PreOpen matching processing according to the present disclosure is described. Referring to FIG. 6A, the top of a book of orders for repos may include offer orders from users A, B and C respectively having offer sizes 300, 150 and 50, where each offer order has an offer price of 0.5% interest, and bid orders from users D, E and F respectively having bid sizes 100, 100 and 100, where each bid order has a bid price of 0.5% interest. The bid price of 0.5% interest and the offer price of 0.5% interest each constitute a top of the book price level tier on a respective side of the book. The processor 114 may determine that order matches are possible between the offer orders of the users A, B and C, which are at a best price level tier at a top of the book price level tier on the offer side, and the bid orders of the users D, E and F, which are at a best price level tier at a top of the book price level tier on the bid side. Referring to FIG. 6A, the processor 114 would determine that the total bid size 250 is smaller than the total offer size 500, such that the bid side is the aggressing side and the opposite side of the offer side is the resting side.

Referring to FIGS. 6A and 6B, a pro rata matching size of a resting order would be determined for orders of each of users D, E and F, which are all of the best price level tier on the aggressing side. A pro rata matching size for the resting order of user A is computed as (300)(300)/500 or 180, where the size of the resting order of user A is 300, the total size of the resting orders at the top of the book price level tier is 500 and the total size of aggressing orders at the best price level tier on the aggressing side is 300. A pro rata matching size for the resting order of user B is computed as (150)(300)/500 or 90, and a pro rata matching size for the resting order of user C is computed as (50)(300)/500 or 30. Further referring to FIG. 6B, where the minimum trade quantity is 50, normalization would adjust the pro rata matching sizes of 180, 90 and 30 of users A, B and C to become pro rata matching sizes of 200, 100 and 50, respectively.

Referring to FIG. 6C, in sequence, a size 100 of user A's order is identified for a match with the entirety of the size 100 of user D's order, a size 100 of user A's order is identified for a match with the entirety of the size 100 of user E's order, and a size 100 of user B's order is identified for a match with the entirety of the size 100 of user E's order.

Referring to FIG. 6D, the possible order matches determined from the PreOpen process reduce user A's order from 300 to 100 and user B's order from 150 to 50, and user C's order remains unchanged. Based on the possible matching orders, the entireties of user D's, E's and F's orders are completely filled.

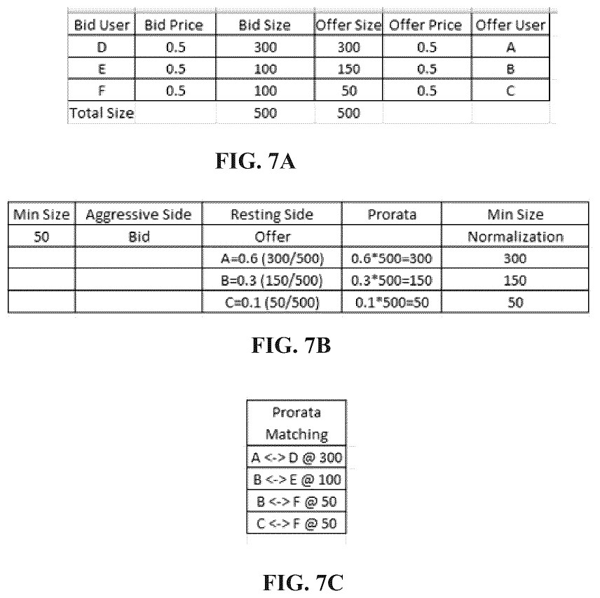

Referring to FIGS. 7A, 7B and 7C, an exemplary implementation of the process 400 to facilitate an auction including a PreOpen matching process according to the present disclosure is described. Referring to FIG. 7A, the top of a book of order for repos may include offer orders from users A, B and C respectively having offer sizes 300, 150 and 50, where each offer order has an offer price of 0.5% interest, and bid orders from users D, E and F respectively having bid sizes 300, 100 and 100, where each bid order has a bid price of 0.5% interest. The bid price of 0.5% interest and the offer price of 0.5% interest each constitute a top of the book price level tier on a respective side of the book. The processor 114 may determine that order matches are possible between the offer orders of the users A, B and C, which are at a best price level tier at a top of the book price level tier on the offer side, and the bid orders of the users D, E and F, which are at a best price level tier at a top of the book price level tier on the bid side. Referring to FIG. 7A, the processor 114 would determine that the total sizes of orders at the top of the book price level tier on each side are the same (500), such that a side of the book that first received an order at the best price level tier is determined to be the aggressing side, which in the example is the bid side.

Referring to FIGS. 7A and 7B, a pro rata matching size of a resting order would be determined for orders of each of users D, E and F, which are all of the best price level tier on the aggressing side. A pro rata matching size for the resting order of user A is computed as (300)(500)/500 or 300, where the size of the resting order of user A is 300, the total size of the resting orders at the top of the book price level tier is 500 and the total size of aggressing orders at the best price level tier on the aggressing side is 500. A pro rata matching size for the resting order of user B is computed as (150)(500)/500 or 150, and a pro rata matching size for the resting order of user C is computed as (50)(500)/500 or 50. Further referring to FIG. 7B, where the minimum trade quantity is 50, normalization does not change the pro rata matching sizes of 300, 150 and 50 respectively of users A, B and C.

Referring to FIG. 7C, in sequence, a size 300 of user A's order is identified for a match with the entirety of the size 300 of user D's order, a size 100 of user B's order is identified for a match with the entirety of the size 100 of user E's order, a remaining size 50 of user B's order is identified for a match with a size 50 of user F's order, and the entirety of the size 50 of user C's order is identified for a match with a remaining size 50 of user F's order.

Thus, the possible order matches determined from the PreOpen matching process result in all of user A's, B's, C's, D's, E's and F's orders being completely filled upon atomic matching when the auction commences.

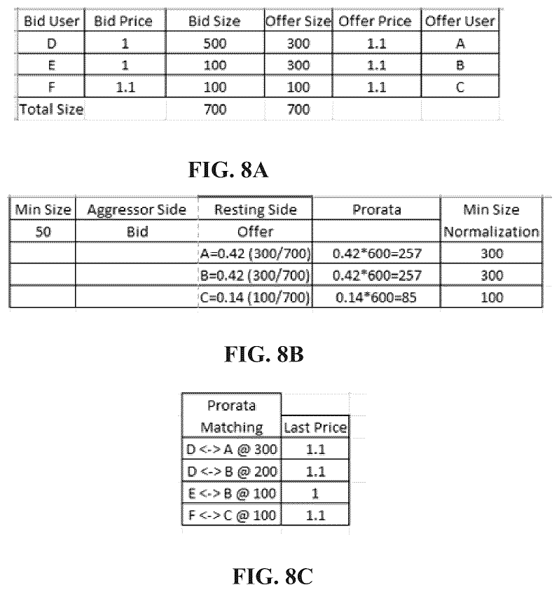

Referring to FIGS. 8A, 8B and 8C, an exemplary implementation of the process 400 to facilitate an auction including a PreOpen matching process according to the present disclosure is described. Referring to FIG. 8A, the top of a book of orders for repos may include offer orders from users A, B and C respectively having offer sizes 300, 300 and 100, where each offer order has an offer price of 1.1% interest, and bid orders from users D, E and F respectively having bid sizes 500, 100 and 100, where the bid orders of users D and E have a bid price of 1.0% interest and the bid order of user F has bid price of 1.1% interest. The bid price of 1.0% interest and the offer price of 1.1% interest each constitute a top of the book price level tier on a respective side of the book. The processor 114 may determine that order matches are possible between the offer orders of the users A, B and C, which are at a best price level tier at a top of the book price level tier on the offer side, and the bid orders of the users D, E and F, which are at a best price level tier and a next best price level below the best price level tier at a top of the book on the bid side. Referring to FIG. 8A, the processor 114 would determine that the total sizes of orders at the top of the book price level tier on each side are the same 700, such that a side of the book that first received an order at the best price level tier is determined to be the aggressing side, which in this example is the bid side.

Referring to FIGS. 8A and 8B, a pro rata matching size of a top of the book price level tier resting order would be determined for orders of each of users D, E and F. The orders of the users D and E are at a same, best price level tier on the aggressing side, and the order of the user F is at a next best price level tier on the aggressing side, and the orders of each of the users D, E and F may be matched with a resting order at the top of the book price level tier on the resting side. For repo trading based on the interest rate of the security, a user that is a seller of a repo is willing to enter into a trade at an offered interest rate price rate or lower. For example, user B, who offers a repo of 1.1% interest, is willing to enter into a trade at that rate or lower. A user that is buyer of a repo is willing to enter into a trade for a price (cash) that would receive interest of the bid rate or higher. In other words, in repo trading, the buyer enters a bid order for the lowest interest rate that a repo security can be purchased, and the seller enters an offer order at the highest interest rate that a repo security can be sold.

Referring to FIG. 8B, a pro rata matching size for the resting order of user A is computed as (300)(600)/700 or 257, where the size of the resting order of user A is 300, the total size of the resting orders at the top of the book price level tier is 700 and the total size of aggressing orders at the best price level tier on the aggressing side is 600. A pro rata matching size for the resting order of user B is computed as (300)(600)/700 or 257, and a pro rata matching size for the resting order of user C is computed as (100)(600)/700 or 85. Further referring to FIG. 8B, where the minimum trade quantity is 50, normalization changes the pro rata matching sizes of 257, 257 and 85 of users A, B and C to 300, 300 and 100 respectively.

In one embodiment, where the buy/sell prices for the trade are not the same, the price of the smaller order of the possible order match is utilized for the possible order match.

In the example, where the price of the smaller order of the possible order match is utilized for the possible order match if order and buy prices are different, referring to FIG. 8C, first, the entire size 300 of user A's order is identified for a match with a size 300 of user D's order at the offer price of 1.1% interest, which completely fills user A's order and reduces user D's order to 200. As seen, for the possible order matches of users A and D, the offer price of 1.1% interest of the smaller order of A is used to determine the possible order match. Then, a size 200 of user B's order is identified for a match with the remaining size 200 of user D's order, also at the offer price of 1.1% interest, which completely fills the order of user D. Next, the remaining size 100 of the order of user B is identified for a match with the entirety of the size 100 of the order of user E at the bid price of 1.0% interest, which fills the orders of user B and user E. Then, a size 100 of the order of user C is identified for a match with a size 100 of the order of user F at the price 1.1% interest, completely filling the orders of users C and F.

Thus, the possible order matches determined from the PreOpen matching process result in all of user A's, B's, C's, D's, E's and F's orders being completely filled upon atomic match when the auction commences.

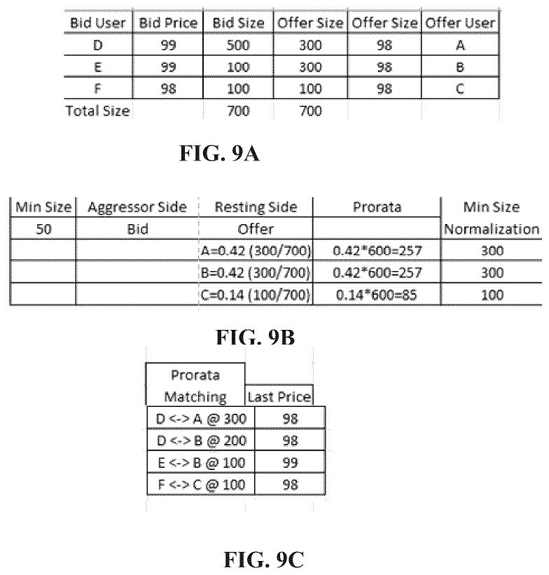

Referring to FIGS. 9A, 9B and 9C, an exemplary implementation of the process 400 to facilitate an auction including a PreOpen matching process based on a cash price as a bid or offer price for a repo according to the present disclosure is described. Referring to FIG. 9A, assuming the offer and bid prices are in U.S. dollars, the top of a book of orders for repos may include offer orders from users A, B and C respectively having offer sizes 300, 300 and 100, where each offer order has an offer price of 98, and bid orders from users D, E and F respectively having bid sizes 500, 100 and 100, where the bid orders of users D and E have a bid price of 99 and the bid order of user F has bid price of 98. The bid price of 99 and the offer price of 98 each constitute a top of the book price level tier on a respective side of the book. The processor 114 may determine that order matches are possible between the offer orders of the users A, B and C, which are at a best price level tier at a top of the book price level tier on the offer side, and the bid orders of the users D, E and F, which are at a best price level tier and a next best price level below the best price level tier at a top of the book on the bid side. Referring to FIG. 9A, the processor 114 would determine that the total sizes of orders at the top of the book price level tier on each side are the same (700), such that a side of the book that first received an order at the best price level tier is determined to be the aggressing side, which in this example is the bid side.

Referring to FIGS. 9A and 9B, a pro rata matching size of a top of the book price level tier resting order would be determined for orders of each of users D, E and F. The users D and E are at same, best price level tier on the aggressing side and the user F is at a next best price level tier on the aggressing side, and orders of each of the users D, E and F may be matched with a resting order at the top of the book price level tier on the resting side. For repo trading, a user that is a seller of a repo is willing to enter into a trade for a repo at an offered cash price or higher, and a user that is buyer of a repo is willing to enter into a trade for a bid cash price or lower. In other words, in repo trading based on the cash price of a repo, the buyer enters a bid order at the highest cash price that the buyer willing to purchase a repo, and the seller enters an offer order at the lowest cash price that the seller is willing to sell a repo.

Referring to FIG. 9B, a pro rata matching size for the resting order of user A is computed as (300)(600)/700 or 257, where the size of the resting order of user A is 300, the total size of the resting orders at the top of the book price level tier is 700 and the total size of aggressing orders at the best price level tier on the aggressing side is 600. A pro rata matching size for the resting order of user B is computed as (300)(600)/700 or 257, and a pro rata matching size for the resting order of user C is computed as (100)(600)/700 or 85. Further referring to FIG. 9B, where the minimum trade quantity is 50, normalization changes the pro rata matching sizes of 257, 257 and 85 of users A, B and C to 300, 300 and 100 respectively.

In one embodiment, where the buy/sell prices for the possible order match are not the same, the price of the smaller order of the possible order match is utilized for the possible order match.

In the example, where the price of the smaller order of the possible order match is utilized for the possible order match if order and buy prices are different, referring to FIG. 9C, a size 300 of user A's order is identified for a match with a size 300 of user D's order at the offer price of 98, which completely fills user A's order and reduces user D's order to 200. Then, a size 200 of user B's order is identified for a match with the remaining unfilled size 200 of user A's order, also at the offer price of 98, which completely fills the order of user D. As seen, for the possible order matches of users A and D and B and D, the offer price of 98 of the smaller order of user A is used, such that the user D benefits by paying less (98) than the bid price (99) for the repo. Next, the remaining size 100 of the order of user B is identified for a match with the entirety of the size 100 of the order of user E at the bid price of 99, which fills the orders of user B and user E. Then, a size 100 of the order of user C is identified for a match with a size 100 of the order of user F at the offer price 98, completely filling the orders of users C and F.

Thus, the possible order matches determined from the PreOpen matching process results in all of user A's, B's, C's, D's, E's and F's orders being completely filled upon atomic match when the auction commences.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein. Rather, various steps can be handled in a different order or simultaneously, and steps may be omitted or added.

1. An electronic trading system comprising:
at least one processor configured to control:
electronically timing, by an electronic timer, a first time interval, in which the first time interval ends prior to a time that an auction commences;
operating in a PreOpen state while the first time interval being timed by the electronic timer has not elapsed;
when operating in the PreOpen state,
receiving, over a communication network, from a plurality of computing devices of respective users, orders for the auction, in which each order indicates price, side and size;
determining a time stamp for each of the orders corresponding to a time of receipt; and
storing, in a memory, each of the orders as bids and offers arranged by price and size in a book;
when the first time interval being timed by the electronic timer has elapsed, switching from operating in the PreOpen state to operating in a LockIn state for a second time interval, and electronically timing the second time interval by the electronic timer, in which the second time interval ends prior to the time that the auction commences, and in which when the LockIn state is switched to from the PreOpen state, each order in the book received in the PreOpen state is fixed;
when operating in the LockIn state,
determining whether at least one order match is possible at top of the book price level tiers of respective bid orders and offer orders in the book;
when at least one order match is determined to be possible for the top of the book price level tiers of the book,
determining an aggressing side based on a total size of orders at the top of the book price level tiers including at least one order match determined to be possible,
determining each aggressing order at each price level tier of the top of the book price level tiers having a possible order match, in best price level tier to worst price level tier order starting from the top of the book price level tier of the aggressing side,
in which at least some portion of an aggressing order at a given price level tier is determined to match pro rata with at least some portion of a resting order on a resting side, until an aggressing order at the given price level tier can no longer be determined to match pro rata with a given resting order on the resting side, and
in which a pro rata matching size for a first resting order on the resting side is determined based on a size of the first resting order divided by a total order size of the resting side multiplied by a total order size of the aggressing side at the top of the book price level tier; and
at the time that the auction commences, atomic matching each given possible order match determined in the LockIn State.

2. The system of claim 1, in which the aggressing side is:
when total order sizes respectively of bid and offer sides of orders determined to be possible to match are the same, a side that first received an order that is determined to be possible to match, and
when total order sizes respectively of bid and offer sides of orders determined to be possible to match are different, a side having a smaller total order size.

3. The system of claim 1, wherein the at least one processor is configured to control adjusting remaining quantities of a given resting order, based on the pro rata matching size for the first resting order.

4. The system of claim 1, wherein the at least one processor is configured to control, when the auction has commenced and following the atomic matching, attempting to match a remaining unmatched or partially filled order from the book in the auction.

5. The system of claim 1, wherein the at least one processor is configured to control, before the atomic matching, transmitting, over the communication network, an auction open notification to the plurality of computing devices.

6. The system of claim 1, wherein the at least one processor is configured to control, after the atomic matching, transmitting, over the communication network, order size information indicating a state of fill of a given order to a given computing device of the computing devices from which the given order was received.

7. The system of claim 1, wherein the at least one processor is configured to control, when operating in the PreOpen state,
displaying, over the communication network, at a display of a given computing device of the computing devices, each given order submitted by the given computing device; and
preventing display at the display of the given computing device of any other order submitted by another given computing device.

8. The system of claim 1, wherein the at least one processor is configured to control, when operating in the LockIn state, notifying by an alert on displays respectively of the computing devices that a change to an order or new order is not allowed.

9. The system of claim 1, wherein the orders are orders for a repurchase agreement (“repo”).

10. The system of claim 1, in which a given pro rata matching quantity for a given resting order is rounded up to a nearest multiple of a minimum trade quantity as a normalized pro rata matching size.

11. A method comprising:
controlling, by at least one processor:
electronically timing, by an electronic timer, a first time interval, in which the first time interval ends prior to a time that an auction commences;
operating in a PreOpen state while the first time interval being timed by the electronic timer has not elapsed;
when operating in the PreOpen state,
receiving, over a communication network, from a plurality of computing devices of respective users, orders for the auction, in which each order indicates price, side and size;
determining a time stamp for each of the orders corresponding to a time of
storing, in a memory, each of the orders as bids and offers arranged by price and size in a book;
when the first time interval being timed by the electronic timer has elapsed, switching from operating in the PreOpen state to operating in a LockIn state for a second time interval, and electronically timing the second time interval by the electronic timer, in which the second time interval ends prior to the time that the auction commences, and in which when the LockIn state is switched to from the PreOpen state, each order in the book received in the PreOpen state is fixed;
when operating in the LockIn state,
determining whether at least one order match is possible at top of the book price level tiers of respective bid orders and offer orders in the book;
when at least one order match is determined to be possible for the top of the book price level tiers of the book,
determining an aggressing side based on a total size of orders at the top of the book price level tiers including at least one order match determined to be possible,
determining each aggressing order at each price level tier of the top of the book price level tiers having a possible order match, in best price level tier to worst price level tier order starting from the top of the book price level tier of the aggressing side,
in which at least some portion of an aggressing order at a given price level tier is determined to match pro rata with at least some portion of a resting order on a resting side, until an aggressing order at the given price level tier can no longer be determined to match pro rata with a given resting order on the resting side, and
in which a pro rata matching size for a first resting order on the resting side is determined based on a size of the first resting order divided by a total order size of the resting side multiplied by a total order size of the aggressing side at the top of the book price level tier; and
at the time that the auction commences, atomic matching each given possible order match determined in the LockIn State.

12. The method of claim 11, in which the aggressing side is:
when total order sizes respectively of bid and offer sides of orders determined to be possible to match are the same, a side that first received an order that is determined to be possible to match, and
when total order sizes respectively of bid and offer sides of orders determined to be possible to match are different, a side having a smaller total order size.

13. The method of claim 11, further comprising controlling, by the at least one processor, adjusting remaining quantities of a given resting order, based on the pro rata matching size for the first resting order.

14. The method of claim 11, further comprising controlling, by the at least one processor, when the auction has commenced and following the atomic matching, attempting to match a remaining unmatched or partially filled order from the book in the auction. The method of claim 11, further comprising controlling, by the at least one processor, before the atomic matching, transmitting, over the communication network, an auction open notification to the plurality of computing devices.

16. The method of claim 11, further comprising controlling, by the at least one processor, after the atomic matching, transmitting, over the communication network, order size information indicating a state of fill of a given order to a given computing device of the computing devices from which the given order was received.

17. The method of claim 11, further comprising controlling, by the at least one processor, when operating in the PreOpen state,
displaying, over the communication network, at a display of a given computing device of the computing devices, each given order submitted by the given computing device; and
preventing display at the display of the given computing device of any other order submitted by another given computing device.

18. The method of claim 11, further comprising controlling, by the at least one processor, when operating in the LockIn state, notifying by an alert on displays respectively of the computing devices that a change to an order or new order is not allowed.

19. The method of claim 11, wherein the orders are orders for a repurchase agreement (“repo”).

20. A non-transitory storage medium configured to store instructions which, when executed by at least one processor, control:
electronically timing, by an electronic timer, a first time interval, in which the first time interval ends prior to a time that an auction commences;
operating in a PreOpen state while the first time interval being timed by the electronic timer has not elapsed;
when operating in the PreOpen state,
receiving, over a communication network, from a plurality of computing devices of respective users, orders for the auction, in which each order indicates price, side and size;
determining a time stamp for each of the orders corresponding to a time of receipt; and
storing, in a memory, each of the orders as bids and offers arranged by price and size in a book;
when the first time interval being timed by the electronic timer has elapsed, switching from operating in the PreOpen state to operating in a LockIn state for a second time interval, and electronically timing the second time interval by the electronic timer, in which the second time interval ends prior to the time that the auction commences, and in which when the LockIn state is switched to from the PreOpen state, each order in the book received in the PreOpen state is fixed;
when operating in the LockIn state,
determining whether at least one order match is possible at top of the book price level tiers of respective bid orders and offer orders in the book;
when at least one order match is determined to be possible for the top of the book price level tiers of the book,
determining an aggressing side based on a total size of orders at the top of the book price level tiers including at least one order match determined to be possible,
determining each aggressing order at each price level tier of the top of the book price level tiers having a possible order match, in best price level tier to worst price level tier order starting from the top of the book price level tier of the aggressing side,
in which at least some portion of an aggressing order at a given price level tier is determined to match pro rata with at least some portion of a resting order on a resting side, until an aggressing order at the given price level tier can no longer be determined to match pro rata with a given resting order on the resting side, and
in which a pro rata matching size for a first resting order on the resting side is determined based on a size of the first resting order divided by a total order size of the resting side multiplied by a total order size of the aggressing side at the top of the book price level tier; and
at the time that the auction commences, atomic matching each given possible order match determined in the LockIn State.
